(19) United States
(12) Patent Application Publication
(10) Pub. No.: US 2013/0333225 A1
(43) Pub. Date: Dec. 19, 2013

(54) DIAGONAL CUTTER AND WIRE STRIPPER TOOL

(71) Applicant: THORSEN TOOLS, INC., ONTARION, CA (US)

(72) Inventor: DAVID MEHOLOVITCH, Glendora, CA (US)

(73) Assignee: THORSEN TOOLS, INC., ONTARION, CA (US)

(21) Appl. No.: 13/906,092

(22) Filed: May 30, 2013

Related U.S. Application Data
(60) Provisional application No. 61/653,031, filed on May 30, 2012.

(51) Int. Cl. H02G 1/12

(52) U.S. Cl. CPC H02G 1/1214
USPC 30/91.2

(57) ABSTRACT

A hand tool includes two levers pivotably coupled at a fulcrom, each lever reciprocal to one another, and each lever including a handle at a lower end and a jaw at an upper end. The jaw includes an edge, and the edge includes a straight angled portion and a notch. The notch includes at least one blade along a perimeter.

### CROSS-REFERENCE TO RELATED APPLICATIONS

This application claims benefit of U.S. provisional patent application Ser. No. 61/651,031, filed May 30, 2012, which is herein incorporated by reference.

### BACKGROUND OF THE INVENTION

1. Field of the Invention

Embodiments of the present invention generally relate to a hand tool that can perform multiple functions. More specifically, embodiments of the present invention relate to a hand tool that is both a diagonal cutter and a wire stripper.

2. Description of the Related Art

A pair of diagonal cutters is a common tool that is used to cut wire. Diagonal cutters have a plier-like appearance, but are typically not used to hold anything in place. Instead, diagonal cutters include jaws that come together at an angle, and cut wire by indenting a wire until it snaps.

A pair of wire strippers is a common tool that is used to remove insulation from a wire. Wire strippers also have a plier-like appearance, and have one or more notches cut out in the jaws with one or more blades around each notch. In use, a wire is placed within a notch of the wire strippers, the blades pierce the insulation without piercing the wire, and when the wire stripper is moved along a length of wire, the wire insulation is removed.

Often, both diagonal cutters and wire strippers are used in the same project. However, a person using both tools usually fumbles around locating one or both tools while working with wires, which may be inconvenient. Therefore, there is a need for a tool that can act as both a wire cutter and diagonal cutter.

### SUMMARY OF THE INVENTION

The present invention generally relates to a hand tool that includes two levers pivotably coupled at a fulcrom, each lever reciprocal to one another, and each lever including a handle at a lower end and a jaw at an upper end. The jaw includes an edge, and the edge includes a straight angled portion and a notch. The notch includes at least one blade along a perimeter.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an embodiment of a tool in an open position from a first side that acts as a diagonal cutter.

FIG. 2 is a perspective view of an embodiment of the tool in a closed position from the first side that acts as a diagonal cutter.

FIG. 3 is a perspective view of an embodiment of the tool in the open position from a second side that acts as a wire stripper.

FIG. 4 is a perspective view of an embodiment of the tool in the closed position from the second side that acts as a wire stripper.

### DETAILED DESCRIPTION

The present invention relates to a hand tool that may both strip insulation from a wire and cut the wire. The function of the tool is dependent on the placement of the wire within jaws of the tool. Along an inner portion of each jaw, an edge is formed that includes both a straight angled portion and a notch that includes at least one blade along a perimeter, the jaws being reciprocal to one another. Thus, if a wire is placed where two straight angled edges of the tool meet, a wire may be cut on a diagonal by squeezing the jaws together. If a wire is placed within a notch, the blade may pierce the insulation while the wire remains unharmed. Further movement of the wire through the notch of the tool allows the insulation of the wire to be stripped.

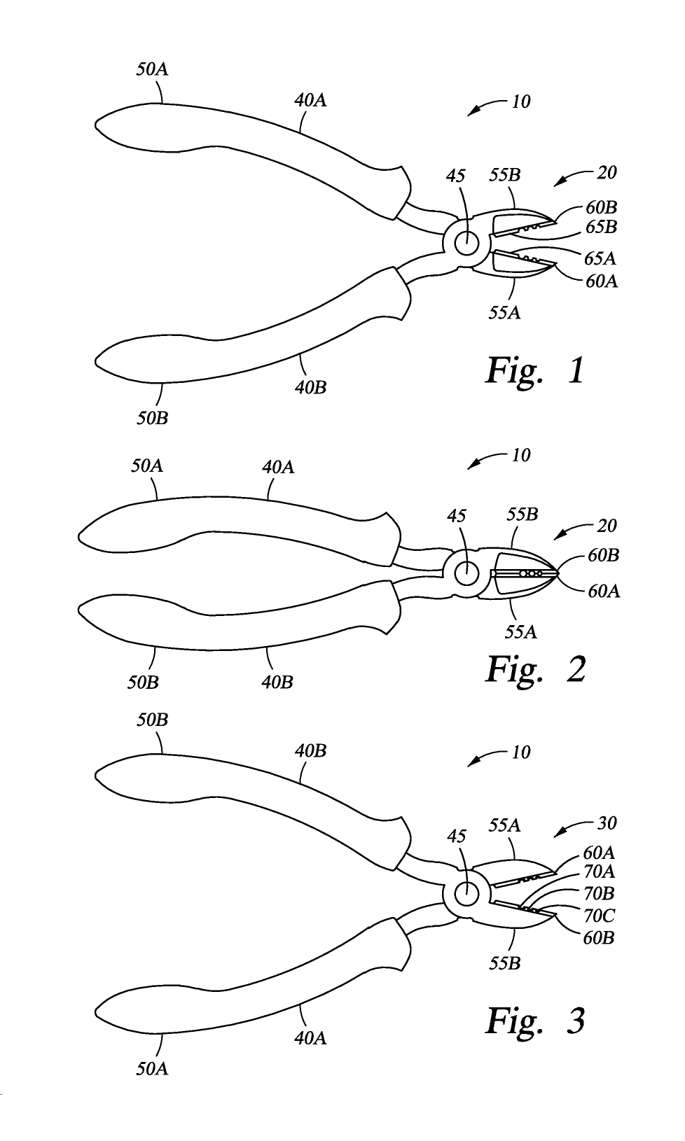

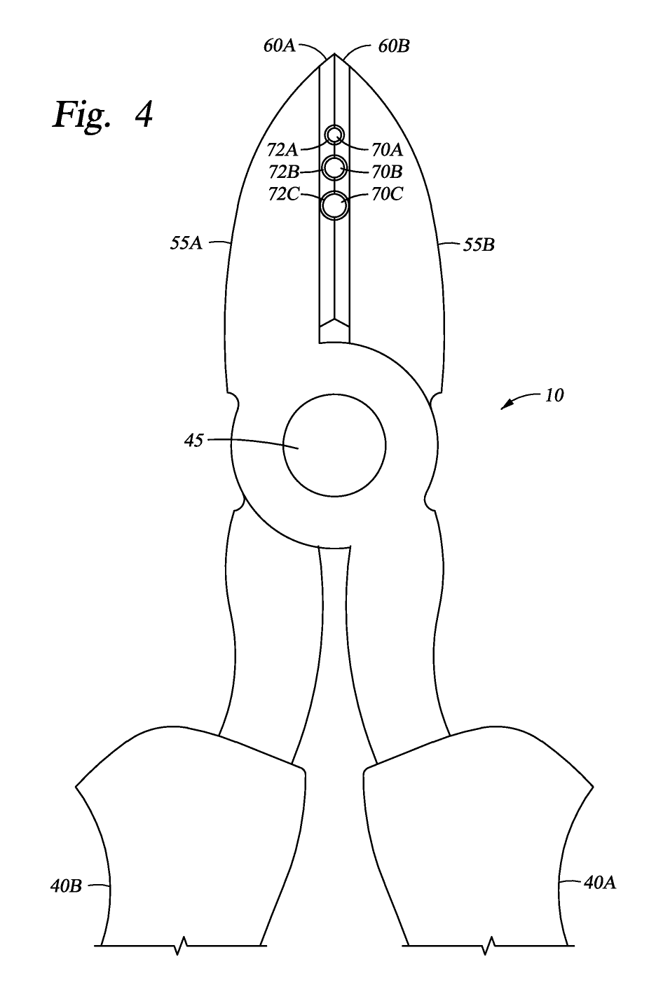

FIGS. 1-4 show an embodiment of a tool 10 in the open and closed positions, with FIGS. 1 and 2 showing the tool 10 from the first side 20 and FIGS. 3 and 4 showing the tool 10 from the second side 30. The tool 10 comprises two levers 40A, B that are pivotably coupled together at a fulcrum 45. The levers 40A, B may be pivotably coupled by a rivet or any other alternate means. Each lever 40A, B includes a handle 50A, B at a lower end and a jaw 55A, B at an upper end. The length of the handles 50A, B is greater than the length of the jaws 55A, B, thus when force is applied at the handles 50A, B, a greater force is imparted at the jaws 55A, B. When the handles 50A, B are spread apart, the jaws 55A, B are also spread apart. Conversely, when the handles 50A, B are squeezed together, the jaws 55A, B are also squeezed together.

Each jaw 55A, B comprises an edge 60A, B at an inner portion of the tool 10. Edge 60A is reciprocal to edge 60B. The edge 60A, B includes at least one straight portion 65A, B that is angled. When the two straight portions 65A, B are joined, a cutting surface is formed by the angled portions, which may allow a wire to be cut on a diagonal. As shown in FIG. 2, when the two handles 50A, B are closed, the jaws 55A, B, close, and edges 60A, B form a V-shape. In the embodiment shown, the edges 60A, B meet in two locations 65A, B to form a cutting surface, but it is contemplated that the edges could meet in alternate or additional locations. In the locations 65A, B where the edges 60A, B meet, a wire may be cut when the wire is placed between the edges 60A, B at a location 65A, B when the tool 10 is in open position (as shown in FIG. 1). When the handles 50A, B are squeezed together, the edges 60A, B will first indent the wire and then cut the wire as the tool 10 is closed (as shown in FIG. 2). Thus, the tool 10 provides the function of a diagonal cutter.

The edges 60A, B also comprise at least one notch 70. In the embodiment shown, the edges 60A, B include three notches 70A, B, C. (See FIGS. 3-4.) The notches 70A, B, C are positioned in reciprocal positions along edges 60A, B. Thus, when the jaws 55A, B are joined together, the notches 70A, B, C form an opening through the closed jaws 55A, B (See FIG. 4). The openings may be circular, shaped like an oval, or any other shape that facilitates the stripping of an insulator from a wire. In one embodiment, a diameter of each opening may be different and correspond to various wire diameters. For example, as shown in FIG. 4, the tool 10 provides notches 70A, B, C for wires that may be 1.0, 1.5 and 2.5 millimeters in diameter. It is contemplated that the notches 70 could be formed to accommodate other wire sizes. Each notch 70A, B, C includes one or more blades along a perimeter of the notch. Accordingly, a wire that is covered with insulation may be placed in a notch 70 that corresponds to width of the wire, the one or more blades will cut through the insulation, but the wire will not be harmed.

To strip insulation from the wire, the wire is placed within a notch 70 of the tool 10 at a certain distance away from the end of the wire while the tool is open. The handles 50A, B are squeezed together, thus closing the jaws 55A, B. When the jaws 55A, B are closed, the one or more blades pierce the insulation. As the tool 10 is moved toward the end of the wire in the closed position, the insulation is removed from the wire, and the wire is unharmed. Thus, the tool 10 provides a wire stripper function.

Both functions of the tool 10—wire stripping and wire cutting—may be used with ease and without any modification to the tool. A user need only adjust the position of the wire within the jaws 55A, B of the tool 10 in order to switch between functions of the tool 10. Therefore, a user no longer needs to fumble to find multiple tools for stripping wires and cutting wires.

While the foregoing is directed to embodiments of the present invention, other and further embodiments of the invention may be devised without departing from the basic scope thereof, and the scope thereof is determined by the claims that follow.

1. A hand tool comprising two levers pivotably coupled at a fulcrom, each lever comprising:
a handle at a lower end; and
a jaw at an upper end, the jaw including an edge, the edge including a straight angled portion and a notch, the notch including at least one blade along a perimeter.

2. The hand tool of claim 1, wherein each lever is reciprocal to the other.

3. The hand tool of claim 1, wherein the straight angled portions of each jaw form a cutting surface when the jaws are joined together.

4. The hand tool of claim 1, wherein the notch of each jaw form an opening when the jaws are joined together.

5. The hand tool of claim 1, wherein the edge includes more than one straight angled portions on each jaw.

6. The hand tool of claim 1, wherein the edge includes more than one notches on each jaw.

7. The hand tool of claim 4, wherein the opening is substantially circular.

8. The hand tool of claim 4, wherein the opening is substantially oval-shaped.

9. The hand tool of claim 6, wherein the notches form circular or oval-shaped openings when the jaws are joined together.

10. The hand tool of claim 9, wherein each notch includes a different radius from the other notches.

11. A hand tool comprising two levers pivotably coupled at a fulcrom, each lever comprising:
a handle at a lower end; and
a jaw at an upper end, the jaw including an edge on an inner portion, the edge including at least one straight angled portion and at least one notch, the at least one notch including at least one blade along a perimeter,
wherein each lever is reciprocal to the other such that when the jaws of each lever are joined, the straight angled portions form a cutting edge and the notches form an opening.

12. The hand tool of claim 11, wherein multiple notches are positioned along the edge.

13. The hand tool of claim 12, wherein the notches form a substantially circular opening when the jaws are closed.

14. The hand tool of claim 13, wherein each notch along a jaw includes a radius that is different from radii of the other notches.

15. A hand tool comprising two levers pivotably coupled at a fulcrom, each lever comprising:
a handle at a lower end; and
a jaw at an upper end, the jaw including an edge, the edge including a straight angled portion and a substantially semi-circular notch, the notch including at least one blade along a perimeter,
wherein each lever is reciprocal to the other.

16. The hand tool of claim 15, wherein each jaw includes more than one semi- circular notches.

17. The hand tool of claim 16, wherein each notch includes a radius that is different from the other notches.

18. The hand tool of claim 15, wherein the straight angled portions form a wire cutter when the jaws are joined together.
